(19) United States
(12) Patent Application Publication
(10) Pub. No.: US 2008/0025628 A1
(43) Pub. Date: Jan. 31, 2008

(54) Enhancement of Blurred Image Portions

(75) Inventor: Gerard De Haan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,743

(22) PCT Filed: Oct. 21, 2005
(86) PCT No.: PCT/IB05/53454

§ 371 Date: Apr. 23, 2007

(30) Foreign Application Priority Data
Oct. 26, 2004 (EP) 04105298.6

(51) Int. Cl. G06K 9/36

(52) U.S. Cl. 382/255

(57) ABSTRACT

This invention relates to a method for image enhancement, comprising a first step (41) of distinguishing blurred and non-blurred image portions of an input image, and a second step (42) of enhancing at least one of said blurred image portions of said input image to produce an output image. Said blurred and non-blurred image portions are for instance distinguished by comparing (416) the differences (415) between a linearly up-scaled (414) version of the down-scaled (411) input image and the input image, and the differences (413) between a non-linearly up-scaled (412) representation of the down-scaled input image and the input image. Said blurred image portion is for instance enhanced by replacing (42) it with a portion of a non-linearly up-scaled representation of the down-scaled input image. The invention also relates to a device, a computer program, and a computer program product.

This invention relates to a method, a computer program, a computer program product and a device for image enhancement.

Images, for instance single-shot portraits or the subsequent images of a movie, are produced to record or display useful information, but the process of image formation and recording is imperfect. The recorded image invariably represents a degraded version of the original scene. Three major types of degradations can occur: blurring, pointwise non-linearities, and noise.

Blurring is a form of bandwidth reduction of the image owing to the image formation process. It can be caused by relative motion between the camera and the original scene, or by an optical system that is out of focus.

Out-of-focus blur is for instance encountered when a three-dimensional scene is imaged by a camera onto a two-dimensional image field and some parts of the scene are in focus (sharp) while other parts are out-of-focus (unsharp or blurred). The degree of defocus depends upon the effective lens diameter and the distance between the objects and the camera.

Film directors usually record foreground tracking shots willingly with a limited focus depth to alleviate the perceived motion judder in background areas. However, modern TVs with motion compensated picture-rate up-conversion can eliminate motion judder in a more advanced way by calculating additional images (in between the recorded images) that show moving objects at the correct position. For these TVs, the blur in the background areas is only annoying.

A limited focus depth may also occur due to poor lighting conditions, or may be created intentionally for artistic reasons.

To combat blur, U.S. Pat. No. 6,404,460 B1 proposes a method and apparatus for image edge enhancement. Therein, the transitions in the video signal that occur at the edges of an image are enhanced. However, to avoid the enhancement of background noise, only transitions of the video signal with an amplitude that is above a certain threshold are enhanced.

The method of U.S. Pat. No. 6,404,460 B1 thus only increases the sharpness of non-blurred portions of an image, where transitions are well pronounced, whereas blurred portions are basically left unchanged.

In view of the above-mentioned problem, it is, inter alia, a general object of the present invention to provide a method, a computer program, a computer program product, and a device for enhancing blurred portions of an image.

A method for image enhancement is proposed, comprising a first step of distinguishing blurred and non-blurred image portions of an input image, and a second step of enhancing at least one of said blurred image portions of said input image to produce an output image.

Said input image may be a single image, like a picture, or one out of a plurality of subsequent images of a video, as for instance a frame of an MPEG video stream. In a first step, blurred and non-blurred image portions of said input image are distinguished. Therein, an image portion may represent a pixel, or a group of pixels of said input image. Non-blurred image portions may for instance be considered as portions of said input image that have a sharpness above a certain threshold, whereas the blurred image portions of said input image may have a sharpness below a certain threshold. There may well be several blurred image portions, which may be adjacent or separated, and, correspondingly, there may well be several non-blurred image portions, which may also be adjacent or separated. Said blurred image portions may for instance represent the background of an image of a video that has been recorded with limited focus depth and thus is out of focus, or may be caused by relative motion between the camera and the original scene. Equally well, said blurred image portions may represent foreground portions of an image, wherein the back-ground is non-blurred. Furthermore, said input image may only comprise blurred image portions, or only non-blurred image portions. A variety of criteria and techniques may be applied in said first step to distinguish blurred and non-blurred image portions of said input image.

In said second step, at least one blurred image portion that has been distinguished in said first step is enhanced. If several blurred image portions have been detected, all of them may be enhanced. Said enhancement may for instance be accomplished by replacing said blurred image portion in said input image by an enhanced blurred image portion. The enhancement of the at least one blurred image portion of said input image leads to the production of an output image that at least contains said enhanced blurred image portion. For instance, said output image may represent the input image, except the image portion that has been replaced by the enhanced blurred image portion.

Said enhancement may refer to all types of image processing that causes an improvement of the objective portrayal or subjective reception of the output image as compared to the input image. For instance, said enhancement may refer to deblurring, or to changing the contrast, brightness or colour constellation of an image portion.

The present invention thus proposes to distinguish blurred and non-blurred image portions of an input image first, and then to enhance blurred image portions to produce an improved output image in dependence on the outcome of this blurred/non-blurred distinction. Distinguished blurred image portions are thus enhanced in any case, whereas in prior art, only non-blurred image portions are enhanced to avoid increase of background noise. The approach according to the present invention thus only enhances the image portions that actually require enhancement, so that a superfluous or possibly quality degrading enhancement of non-blurred image portions is avoided and, consequently, the computation effort can be significantly reduced and image quality can be increased. As the decision on the image portions that are enhanced does not necessarily have to be based on measures like for instance the amplitude of transitions of an image signal, a more concise enhancement of blurred image portions rather than noisy image portions can be accomplished.

According to a preferred embodiment of the present invention, said non-blurred image portions are not enhanced. This allows for an extremely simple and computationally efficient set-up. Then only the blurred image portions are enhanced, and the output image may for instance be easily achieved by replacing the blurred image portions with enhanced blurred image portions. However, some amount of processing may still be applied to said non-blurred image portions, for instance a different type of enhancement than the enhancement that is applied to the blurred image portions. This application of different enhancement techniques for non-blurred and blurred image portions is only possible due to the distinguishing between blurred and non-blurred image portions according to the first step of the present invention.

According to a further preferred embodiment of the present invention, said first step comprises transforming at least a portion of said input image according to a first transformation to obtain a transformed input image portion; enhancing a representation of said transformed input image portion to obtain an enhanced transformed input image portion; and processing at least said portion of said input image, said enhanced transformed input image portion, and one of said transformed input image portion and an image portion, which is obtained by transforming said transformed input image portion according to a second transformation, to distinguish said blurred and non-blurred image portions of said input image.

At least a portion, for instance a pixel or a group of pixels, of said input image are transformed according to a first transformation. Equally well, said complete input image may be transformed. Said first transformation may for instance reduce or eliminate spectral components of said portion of said input image, for instance, a blurring or down-scaling of said portion of said input image may take place.

A representation of said transformed input image portion is then enhanced. Therein, said representation of said transformed input image portion may be said transformed input image portion itself, or an image portion that resembles said transformed input image portion or is otherwise related to said transformed input image portion. For instance, said representation of said transformed input image portion may be a transformed version of an already enhanced image portion.

Said representation of said transformed input image portion is then enhanced to obtain an enhanced transformed input image portion. Said enhancing may for instance aim at a restoration or estimation of spectral components of said portion of said input image that was reduced or eliminated during said first transformation. For instance, if said first transformation performed a blurring or a down-scaling of said portion of said input image, said enhancing may aim at a de-blurring or non-linear up-scaling of said transformed input image portion, respectively.

Said second transformation may be related to said enhancing in a way that similar targets are pursued, but wherein different algorithms are applied to reach the target. For instance, if said first transformation causes a down-scaling of said portion of said input image, and said enhancing aims at a non-linear up-scaling of said transformed input image portion, said second transformation may for instance aim at a linear up-scaling of said transformed input image.

The rationale behind the approach according to this embodiment of the present invention is the observation that blurred and non-blurred image portions react differently to said first transformation and the subsequent enhancing. Whereas blurred image portions are significantly modified by said first transformation and said subsequent enhancing, non-blurred image portions are less modified by said first transformation and said subsequent enhancing. To obtain a reference image portion, the image portion of said input image is also subject to said first transformation and possibly a second transformation, and the reference image portion obtained in this way then may be processed together with said enhanced transformed input image and said portion of said input image to distinguish blurred and non-blurred image portions of said input image.

Said processing may for instance comprise forming differences between said portion of said input image and said enhanced transformed input image portion on the one hand, and between said portion of said input image and the reference image portion (either said transformed input image portion or said other image portion obtained from said second transformation) on the other hand, and comparing these differences.

According to a further preferred embodiment of the present invention, said processing to distinguish said blurred and non-blurred image portions of said input image comprises determining first differences between said enhanced transformed input image portion and said portion of said input image; determining second differences between said transformed input image portion or said image portion, which is obtained by transforming said transformed input image portion according to said second transformation, and said portion of said input image; and comparing said first and second differences to distinguish blurred and non-blurred image portions of said input image.

Comparing the modifications in a portion of an input image induced by an enhancement processing chain that comprises said first transformation of a portion of an input image and said enhancing with the modifications in said portion of said input image induced by a reference processing chain that comprises said first transformation of said portion of said input image and possibly a second transformation allows to distinguish if the considered portion of said input image (or parts thereof) is blurred or non-blurred, as blurred and non-blurred image portions react differently to said first transformation and said subsequent enhancing.

According to a further preferred embodiment of the present invention, said first transformation causes a reduction or elimination of spectral components of said portion of said input image, and said enhancing aims at a restoration or estimation of spectral components of said representation of said transformed input image portion.

In an originally blurred image portion, no significant spectral components are present, and thus applying said first transformation, e.g. blurring or down-scaling said portion of said input image, does not reduce or eliminate spectral components. However, when enhancing the transformed image portion, e.g. by de-blurring or non-linear up-scaling, in the enhancement chain, spectral components are attempted to be recovered or estimated, although they originally not have been present in said image portion. The enhanced image portion then resembles the original image portion less than an image portion as output by the reference chain, which does not attempt to recover or estimate spectral components. In contrast, in an originally non-blurred image portion, such spectral components are present, these spectral components are actually reduced or eliminated during said first transformation, and attempting to restore or estimate said spectral components during said enhancing of said enhancement chain leads to an image portion that more resembles said original image portion than an image portion output by said reference chain, which does not attempt to recover or estimate spectral components.

According to a further preferred embodiment of the present invention, said first and second steps are repeated at least two times, and in each repetition, a different spectral component is concerned, respectively. This approach allows to deal with different amounts of blurring.

According to a further preferred embodiment of the present invention, said first transformation causes a blurring of said portion of said input image, said enhancing aims at a de-blurring of said representation of said transformed input image portion, said second differences are determined between said transformed input image portion and said portion of said input image, and image portions where said first differences are larger than said second differences are considered as blurred image portions.

According to a further preferred embodiment of the present invention, said first transformation causes a down-scaling of said portion of said input image, said enhancing causes a non-linear up-scaling of said representation of said transformed input image portion, said second differences are determined between said image portion, which is obtained by transforming said transformed input image portion according to said second transformation, and said portion of said input image, said second transformation causes a linear up-scaling of said transformed input image portion, and image portions where said first differences are larger than said second differences are considered as blurred image portions.

Said up-and down-scaling causes a reduction of the width and/or height of image portions that are scaled, and may be represented by respective scaling factors for said width and/or height, or by a joint scaling factor. Said down-scaling is preferably linear. Whereas said linear scaling only comprises linear operations, said non-linear up-scaling may further comprise resolution up-conversion techniques as the PixelPlus, Digital Reality Creation or Digital Emotional Technology techniques that are capable of re-generating, at least some, details that were lost in the down-scaling process and that cannot be re-generated with a linear up-scaling technique.

According to a further preferred embodiment of the present invention, said at least one blurred image portion is enhanced in said second step by replacing it with an enhanced transformed input image portion obtained in said first step.

This embodiment of the present invention is particularly advantageous with respect to a reduced computational complexity, as the enhanced transformed input image portions that are computed as by-products in the process of distinguishing blurred and non-blurred image portions can actually be used to replace the distinguished blurred image portions in the input image to obtain the output image.

According to a further preferred embodiment of the present invention, said first and second steps are repeated in N iterations to produce a final output image from an original input image, wherein in each iteration n=1, . . . ,N, an N-n fold transformed version of at least a portion of said original input image obtained from N−n fold application of said first transformation to said portion of said original input image is used as said portion of said input image, wherein in the first iteration n=1, an N fold transformed version of said portion of said original input image obtained from N fold application of said first transformation to said portion of said original input image is used as said representation of said transformed input image portion, wherein in each other iteration n=2, . . . ,N, at least a portion of said output image produced by the preceding iteration n−1 is used as said representation of said transformed input image portion, and wherein the output image produced in the last iteration n=N is said final output image.

The rationale behind this approach of the present invention is the observation that, since the amount of blurring in the input image can be considerable, best results may be obtained by using several iterations N, for instance to achieve a large down-scaling and up-scaling factor, if said first transformation and said enhancing are directed to down-scaling and non-linear up-scaling, respectively. If N=3 is chosen, the first iteration then starts with a 3-fold transformed version of said portion of said original input image. Setting out from this 3-fold transformed version of said portion of said input image, enhancing and optional a second transformation are performed in parallel, and based on the results, blurred and non-blurred image portions are distinguished and at least one blurred image portion is enhanced to obtain an output image of this first iteration. In the second iteration, enhancing is performed for at least a portion of this output image of the previous iteration, and optionally said second transformation is performed for the 2-fold transformed portion of said original input image. Based on the comparison of the results, this second iteration produces an output image with enhanced blurred image portions that serves as an input to the next iteration, etc. Finally, the output image obtained in the third iteration is used as the final output image of the enhancement procedure.

According to a further preferred embodiment of the present invention, N equals 3. Said number of iterations may allow for a good trade-off between image quality and computational effort.

According to a further preferred embodiment of the present invention, said non-linear up-scaling is performed according to the PixelPlus, Digital Reality Creation or Digital Emotional Technology technique. Said non linear up-scaling techniques, when applied to down-scaled images, generally outperform linear up-scaling techniques in particular for the in-focus image portions, because they may re-generate, at least some, details that were lost in the down-scaling process.

It is further proposed a computer program with instructions operable to cause a processor to perform the above-described method steps.

It is further proposed a computer program product comprising a computer program with instructions operable to cause a processor to perform the above-mentioned method steps.

It is further proposed a device for image enhancement, comprising first means arranged for distinguishing blurred and non-blurred image portions of an input image, and second means arranged for enhancing at least one of said blurred image portions of said input image to produce an output image.

According to a first preferred embodiment of a device of the present invention, said first means comprises: means arranged for transforming at least a portion of said input image according to a first transformation to obtain a transformed input image portion; means arranged for enhancing a representation of said transformed input image portion to obtain an enhanced transformed input image portion; and means arranged for processing at least said portion of said input image, said enhanced transformed input image portion and an image portion, which is obtained by transforming said transformed input image portion according to a second transformation, to distinguish said blurred and non-blurred image portions of said input image.

According to a further preferred embodiment of the present invention, said means arranged for processing at least said portion of said input image, said enhanced transformed input image portion and said image portion, which is obtained by transforming said transformed input image portion according to a second transformation, comprises means arranged for determining first differences between said enhanced transformed input image portion and said portion of said input image; means arranged for determining second differences between said image portion, which is obtained by transforming said transformed input image portion according to said second transformation, and said portion of said input image; and means arranged for comparing said first and second differences to distinguish blurred and non-blurred image portions of said input image.

According to a further preferred embodiment of the present invention, said first means comprises means arranged for transforming at least a portion of said input image according to a first transformation to obtain a transformed input image portion; means arranged for enhancing a representation of said transformed input image portion to obtain an enhanced transformed input image portion; and means arranged for processing at least said portion of said input image, said enhanced transformed input image portion and said transformed input image portion to distinguish said blurred and non-blurred image portions of said input image.

According to a further preferred embodiment of the present invention, said means arranged for processing at least said portion of said input image, said enhanced transformed input image portion and said transformed input image portion comprises means arranged for determining first differences between said enhanced transformed input image portion and said portion of said input image; means arranged for determining second differences between said transformed input image portion and said portion of said input image; and means arranged for comparing said first and second differences to distinguish blurred and non-blurred image portions of said input image.

According to a further preferred embodiment of the present invention, said first and second means form a unit, wherein N of these units are interconnected as a cascade that produces a final output image from an original input image, wherein in each unit n=1, . . . ,N, an N−n fold transformed version of at least a portion of said original input image obtained from N−n fold application of said first transformation to said portion of said original input image is used as said input image, wherein in the first unit n=1, an N fold transformed version of said portion of said original input image obtained from N fold application of said first transformation to said portion of said original input image is used as said representation of said transformed input image portion, wherein in each other unit n=2, . . . ,N, at least a portion of said output image as produced by the preceding unit n−1 is used as said representation of said transformed input image portion, and wherein the output image produced in the last unit n=N is said final output image.

These and other aspects of the invention will be apparent from and elucidated with reference to the embodiments described hereinafter.

In the figures show:

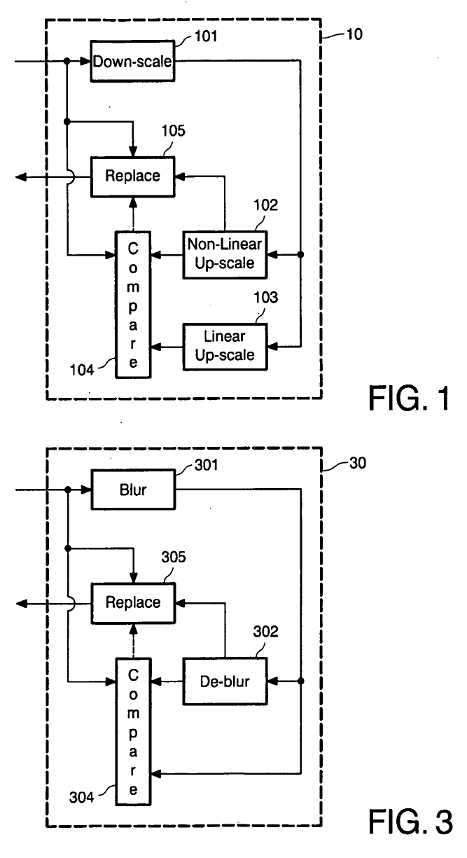

FIG. 1. a schematic presentation of a first embodiment of a device for image enhancement according to the present invention;

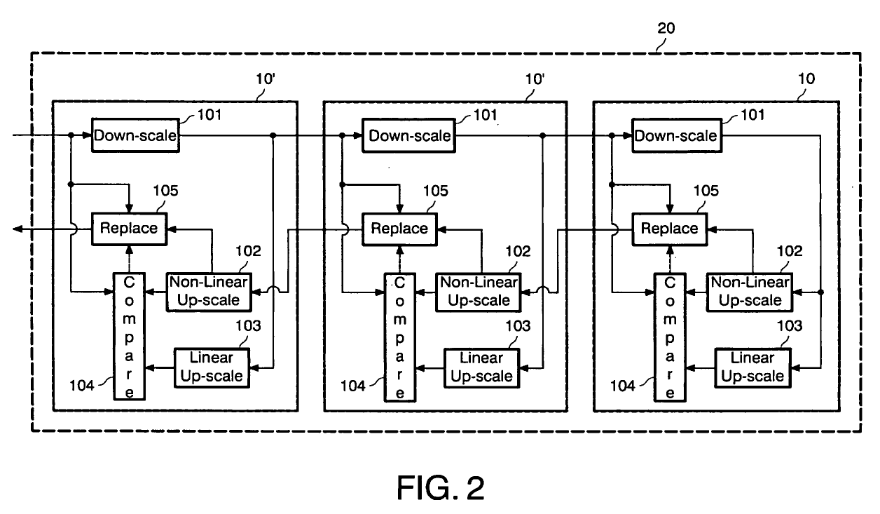

FIG. 2. a schematic presentation of a second embodiment of a device for image enhancement according to the present invention;

FIG. 3. a schematic presentation of a third embodiment of a device for image enhancement according to the present invention; and

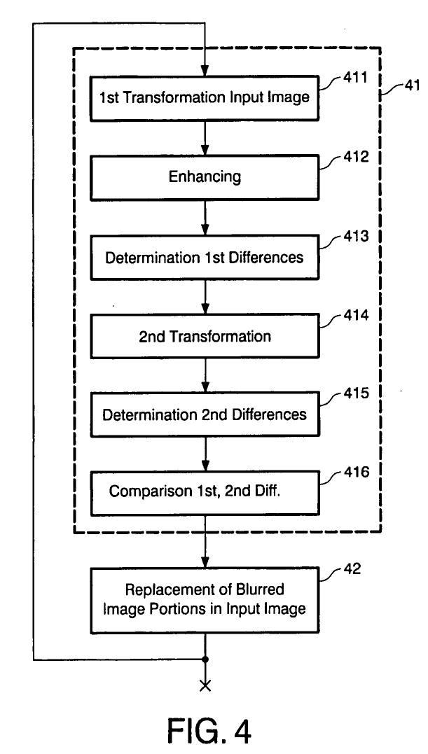

FIG. 4. an exemplary flowchart of a method for image enhancement according to the present invention.

The present invention proposes a simple and computationally efficient technique to enhance blurred image portions of input images, wherein this enhancement may for instance relate to the enhancement of the sharpness of these blurred image portions. To this end, at first blurred and non-blurred image portions in an input image are distinguished, and then at least one of said blurred image portions is enhanced.

FIG. 1 schematically depicts a first embodiment of a device 10 for image enhancement according to the present invention. In this embodiment, the distinguishing between blurred and non-blurred image portions is based on the observation that linear and non-linear up-scaling of down-scaled versions of the input image achieve different results for blurred and non-blurred image portions, so that, based on a comparison of the differences of both up-scaled images with the (original) input image, a distinguishing of said blurred and non-blurred image portions becomes possible. The non-linearly up-scaled image portions can then advantageously be used as enhanced blurred image portions for the replacement of the blurred image portions in the (original) input image. Iterative application of this technique is also possible and may achieve superior enhancement of image quality as compared to a single-step application.

In the device 10 of FIG. 1, the image enhancement technique of the present invention is performed in a single step. To this end, an input image that is to be enhanced, for instance an input image that contains blurred image portions, is fed into a down-scaling instance 101 of said device 10. In said down-scaling instance, width and/or height of said input image are reduced by scaling factors, for instance a common scaling factor may be used for the width and height reduction. In this embodiment, this down-scaling may for instance be linear. For instance, if said input image is down-scaled by a factor of 2 in both spatial dimensions, all spectral components between the old and the new Nyquist border (which is located at half the sampling frequency, respectively) are lost or aliased. The down-scaled input image then is fed into a non-linear up-scaling instance 102, where it serves as representation of the down-scaled input image and is enhanced by non-linear up-scaling, for instance by the PixelPlus technique. In contrast to linear up-scaling, which does not change the spectral content and only maps the same image signal to a finer grid, this non-linear up-scaling maps the image signal to a finer grid and also introduces harmonics between the two Nyquist frequencies. For instance, PixelPlus achieves this by recognizing begin and end of an edge signal in said image signal and replaces the corresponding edge by a steeper one that is centered at the same location as the original edge. A more detailed description of the PixelPlus technique is provided in the publications “A high-definition experience from standard definition video” by E. B. Bellers and J. Caussyn, Proceedings of the SPIE, Vol. 5022, 2003, pp. 594-603, and “Improving non-linear up-scaling by adapting to the local edge orientation” by J. Tegenbosch, P. Hofman and M. Bosma, Proceedings of the SPIE, Vol. 5308, January 2004, pp. 1181-1190. Alternatively, also other non-linear up-scaling techniques may be used, for instance constant adaptive interpolation techniques using neural networks or being based on classification such as Kondo's method (Digital Reality Creation), or Atkin's method (Resolution Synthesis).

The resulting non-linearly up-scaled image is then fed into a comparison instance 104. Similarly, the down-scaled input image is fed into a linear up-scaling instance 103, where it is linearly up-scaled. It should be noted that, due to a possible loss of quality encountered in the down-scaling operation, the linearly up-scaled image may no longer be identical to the input image. The output of the linear up-scaling instance 103 is also fed into the comparison instance 104. Therein, differences Dₗᵢₙ between the linearly up-scaled image and the input image, and differences Dₙₗᵢₙ between the non-linearly up-scaled image and the input image are determined, for instance for each pixel or for groups of pixels. The comparison instance 104 then compares the differences Dₗᵢₙ and Dₙₗᵢₙ, for instance on a pixel basis, and identifies image portions where Dₗᵢₙ<Dₙₗᵢₙ holds and image portions were Dₗᵢₙ>Dₙₗᵢₙ holds. In the first case, said image portions are considered as blurred image portions, because, for blurred image portions, linear up-scaling generally generates better results than non-linear up-scaling. In the second case, said image portions are considered as non-blurred image portions, because, for non-blurred image portions, non-linear up-scaling generates better results than linear up-scaling.

Information on the blurred image portions then is fed into a replacement instance 105, which also receives said input image as input. In said replacement instance, the distinguished blurred image portions are replaced by enhanced blurred image portions, for instance portions of the non-linearly up-scaled image as computed in instance 102, which are fed into said replacement instance 105 from said non-linear up-scaling instance 102. The detected non-blurred image portions are not replaced in the replacement instance 105, so that the output image, as output by the replacement instance 105, basically is the input image with replaced blurred image portions.

The present invention thus distinguishes blurred and non-blurred image portions of an input image by exploiting the different performance of linear/non-linear up-scaling of down-scaled input images for blurred/non-blurred image portions and replaces the distinguished blurred image portions with by-products of this detection process.

It is also possible, although less efficient, to replace the distinguished blurred image portions with enhanced image portions that are not generated in instance 102 during the process of distinguishing blurred/non-blurred image portions. This allows to use different enhancement algorithms for the distinguishing of blurred/non-blurred image portions one the one hand and the actual enhancement of distinguished blurred image portions on the other hand.

FIG. 2 schematically depicts a second embodiment of a device 20 for image enhancement according to the present invention, wherein the steps of distinguishing blurred/non-blurred image portions and replacing the blurred image portions are applied to an original input image N=3 times in iterative fashion. Correspondingly, the device 20 comprises three times the device according to the first embodiment of FIG. 1 as sub-devices, with only some minor modifications. The rightmost sub-device 10 in FIG. 2 is identical to the device 10 of FIG. 10, whereas the center sub-device 10′-2 and leftmost sub-device 10′-1 in FIG. 2 are slightly different with respect to the image that is fed into the non-linear up-scaling instance 102. Whereas in sub-device 10, the non-linear up-scaling instance 102 is fed with the output of the down-scaling instance 101, in the sub-devices 10′-1 and 10′-2, the non-linear up-scaling instance 102 is fed with the output image as produced by the respective right sub-device 10 and 10′-2. However, the operation of all sub-devices 10 and 10′-1 and 10′-2 is exactly as described with reference to FIG. 1.

In FIG. 2, an original input image, that is to be enhanced by device 20, travels trough the down-scaling instances 101 of the three sub-devices 10′-1, 10′-2 and 10. If each down-scaling instance 101 applies a down-scaling factor of 2, then the image at the output of instance 101 of sub-device 10 has been 3-fold down-scaled, yielding a total down-scaling factor of 8. This down-scaled image is non-linearly (instance 102) and linearly (instance 103) up-scaled by a factor 2, and then the differences of the non-linearly and linearly up-scaled images and the input image of sub-device 10, which is the original input image down-scaled by a factor of 4, are compared in instance 104 of sub-device 10 to detect non-blurred and blurred image portions. Blurred image portions are replaced in instance 105, and the output image of the replacement instance 105, which also serves as output image of sub-device 10, is fed into the instance 102 of sub-device 10′-2.

In sub-device 10′-2, a 1-fold down-scaled original input image (scaling factor 2) is used for the linear up-scaling, and the output image of subdevice 10 is used for the non-linear up-scaling. Once again linear/non-linear up-scaling differences are compared with respect to the input image of the device 10′-2, which is the 1-fold down-scaled original input image, and enhancement is performed by replacing detected blurred image portions in said input image of said sub-device 10′-2. The output signal of the replacement instance 105 of sub-device 10′-2 is fed into instance 102 of sub-device 10′-1 for non-linear up-scaling.

Finally, in sub-device 10′-1, the original input image serves as input image, an detected blurred image portions are directly replaced in this original output image to obtain the final output image of device 20.

A handy description of the iterative application of the steps of the present invention is available in the form of the following pseudo-code example, wherein, similar to the device 20 in FIG. 3, a 3-step approach is exemplarily described, and wherein, again, the different reaction of blurred and non-blurred image portions to down-scaling and subsequent linear/non-linear up-scaling is exploited (comments start with a double forward slash):

//BEGIN pseudocode example
org=Input
// First generate the 3 scaling levels small, smaller and // smallest by down-scaling
Downscale(org, small);
Downscale(small, smaller);
Downscale(smaller, smallest);
// Non-linearly up-scale smallest to smaller UPNLin,
// linearly up-scale smallest to smallerUPLin and make
// smart combination, which then is contained in
// buffer smallerhelp
UpscaleNLin(smallest, smallerUpNLin);
UpscaleLin(smallest, smallerUpLin);
Combine(smallerUpLin, smallerUpNLin, smaller,
smallerhelp);
// Non-linearly upscale smallerhelp to smallUPNLin,
// linearly up-scale smaller to smallUPLin
// and make smart combination, which then is contained in
// buffer smallhelp
UpscaleNLin(smallerhelp, smallUpNLin);
Combine(smallUpLin, smallUpNLin, small, smallhelp);
// Non-linearly up-scale smallhelp to orgUPNLin,
// linearly up-scale small to orgUPLin
// and make ssmart combination, which then is contained in
// buffer orghelp
UpscaleNLin(smallhelp, orgUpNLin);
UpscaleLin(small, orgUpLin);
Combine(orgUpLin, orgUpNLin, org, orghel);
// Now buffer orghelp contains the output (blur
// enhanced) image
Output=orghelp;
//END pseudocode example

FIG. 3 schematically depicts a third embodiment of a device 30 for image enhancement according to the present invention. In this embodiment, the distinguishing between blurred and non-blurred image portions is based on the observation that performing enhancement and not performing enhancement on an intentionally blurred portion of an input image achieves different results for blurred and non-blurred image portions, so that, based on a comparison of the differences of both the enhanced and the not enhanced intentionally blurred image portions with said portion of said input image, a distinguishing of said blurred and non-blurred image portions becomes possible. The enhanced intentionally blurred image portions can then be used for the replacement of blurred image portions in the (original) input image. Equally well, said distinguished blurred image portions can be enhanced according to a different enhancement technique, and then be replaced in said input image to obtain said output image.

In FIG. 3, an input image that is to be enhanced, for instance an input image that contains blurred image portions, is fed into a blurring instance 301 of said device 30. In said blurring instance 301, the input image is intentionally blurred. The intentiorially blurred input image then is fed into a de-blurring instance 302, wherein it is enhanced with respect to a reduction of blur. The resulting de-blurred image is then fed into a comparison instance 304. The intentionally blurred input image is also directly fed into the comparison instance 304. Therein, first differences between the de-blurred image as output by instance 302 and the original input image, and second differences between the intentionally blurred input image as output by instance 301 and the original input image are determined, for instance for each pixel or for groups of pixels. The comparison instance 304 then compares the first and second differences, for instance on a pixel basis, and identifies image portions where the first differences are smaller than the second differences and image portions were the first differences are equal to or larger than the second differences. In the former case, said image portions are considered as non-blurred image portions, and in the latter case, said image portions are considered as blurred image portions. This is due to the fact that, in case of originally blurred input image portions, where the corresponding spectrum does not contain significant energy, the intentional blurring in instance 301 does not change said input image portions, so that the second difference between the intentionally blurred input image as output by instance 301 and the original input image is small. In contrast, also in case of originally blurred input image portions, the enhancement of the intentionally blurred input image in instance 302 creates spectrum where it originally wasn't, so that the second difference between the enhanced intentionally blurred input image as output by instance 302 and the original input image is large. For non-blurred input image portions, in turn, intentional blurring and subsequent enhancement obtains better results than intentional blurring only. By repeating this procedure for different spectral components, it can be dealt with different amounts of blurring.

Returning to FIG. 3, after the distinguishing of blurred/non-blurred image portions, information on the blurred image portions then is fed into a replacement instance 305, which also receives said input image as input. In said replacement instance 305, the distinguished blurred image portions are replaced by enhanced blurred image portions, which are fed into said replacement instance 305 from said de-blurring instance 302. The detected non-blurred image portions are not replaced in the replacement instance 305, so that the output image, as output by the replacement instance 105, basically is the input image with replaced blurred image portions.

It should be noted that this third embodiment of the present invention can also be combined with down-scaling and up-scaling to obtain an efficient implementation.

FIG. 4 depicts an exemplary flowchart of a method according to the present invention. In a first step 41, blurred and non-blurred image portions of an input image are distinguished. In a second step 42, distinguished blurred image portions are replaced in the input image to obtain an output image. Therein, step 41 comprises the following sub-steps: In a sub-step 411, at least a portion of the input image is transformed according to a first transformation (e.g. blurring or down-scaling) to obtain a transformed input image portion. Subsequently, said transformed input image portion itself or a representation thereof is enhanced (e.g. by de-blurring or non-linear up-scaling) to obtain an enhanced transformed input image portion in sub step 412. First differences between this enhanced transformed input image portion and said portion of said input image are determined in a sub-step 413. In a sub-step 414, the transformed input image portion is optionally transformed according to a second transformation (e.g. linear up-scaling). In sub-step 415, second differences between said portion of said input image and either said transformed input image portion (e.g. if said first transformation represents blurring) or said optionally transformed input image portion being further transformed according to a second transformation (e.g. linear up-scaling in case that said first transformation represents down-scaling) are determined. In a sub-step 416, the first and second differences as determined in sub-steps 413 and 415 are compared to decide which image portions of said input image are blurred and which are non-blurred.

The present invention has been described above by means of preferred embodiments. It should be noted that there are alternative ways and variations which are obvious to a skilled person in the art and can be implemented without deviating from the scope and spirit of the appended claims.

1. A method for image enhancement, comprising:
a first step (41) of distinguishing blurred and non-blurred image portions of an input image, and
a second step (42) of enhancing at least one of said blurred image portions of said input image to produce an output image.

2. The method according to claim 1, wherein said non-blurred image portions are not enhanced.

3. The method according to claim 1, wherein said first step (41) comprises:
transforming (411) at least a portion of said input image according to a first transformation to obtain a transformed input image portion;
enhancing (412) a representation of said transformed input image portion to obtain an enhanced transformed input image portion; and
processing (413, 415, 416) at least said portion of said input image, said enhanced transformed input image portion, and one of said transformed input image portion and an image portion, which is obtained by transforming (414) said transformed input image portion according to a second transformation, to distinguish said blurred and non-blurred image portions of said input image.

4. The method according to claim 3, wherein said processing (413, 415, 416) to distinguish said blurred and non-blurred image portions of said input image comprises:
determining (413) first differences between said enhanced transformed input image portion and said portion of said input image;
determining (415) second differences between said transformed input image portion or said image portion, which is obtained by transforming (414) said transformed input image portion according to said second transformation, and said portion of said input image; and
comparing (416) said first and second differences to distinguish blurred and non-blurred image portions of said input image.

5. The method according to claim 3, wherein said first transformation (411) causes a reduction or elimination of spectral components of said portion of said input image, and wherein said enhancing (412) aims at a restoration or estimation of spectral components of said representation of said transformed input image portion.

6. The method according to claim 5, wherein said first (41) and second (42) steps are repeated at least two times, and wherein in each repetition, a different spectral component is concerned, respectively.

7. The method according to claim 3, wherein said first transformation (411) causes a blurring of said portion of said input image, wherein said enhancing (412) aims at a de-blurring of said representation of said transformed input image portion, wherein said second differences are determined (415) between said transformed input image portion and said portion of said input image, and wherein image portions where said first differences are larger than said second differences are considered as blurred image portions.

8. The method according to claim 3, wherein said first transformation (411) causes a down-scaling of said portion of said input image, wherein said enhancing (412) causes a non-linear up-scaling of said representation of said transformed input image portion, wherein said second differences are determined (415) between said image portion, which is obtained by transforming (414) said transformed input image portion according to said second transformation, and said portion of said input image, wherein said second transformation (414) causes a linear up-scaling of said transformed input image portion, and wherein image portions where said first differences are larger than said second differences are considered as blurred image portions.

9. The method according to claim 3, wherein said at least one blurred image portion is enhanced in said second step (42) by replacing it with an enhanced transformed input image portion obtained in said first step (41).

10. The method according to claim 3, wherein said first (41) and second (42) steps are repeated in N iterations to produce a final output image from an original input image, wherein in each iteration n=1, . . . ,N, an N−n fold transformed version of at least a portion of said original input image obtained from N−n fold application of said first transformation to said portion of said original input image is used as said portion of said input image, wherein in the first iteration n=1, an N fold transformed version of said portion of said original input image obtained from N fold application of said first transformation to said portion of said original input image is used as said representation of said transformed input image portion, wherein in each other iteration n=2, . . . ,N, at least a portion of said output image produced by the preceding iteration n−1 is used as said representation of said transformed input image portion, and wherein the output image produced in the last iteration n=N is said final output image.

11. The method according to claim 10, wherein N equals 3.

12. The method according to claim 8, wherein said non-linear up-scaling (314) is performed according to the PixelPlus, Digital Reality Creation or Digital Emotional Technology technique.

13. A computer program with instructions operable to cause a processor to perform the method steps of claim 1.

14. A computer program product comprising a computer program with instructions operable to cause a processor to perform the method steps of claim 1.

15. A device (10; 30) for image enhancement, comprising:
first means (101, 102, 103, 104; 301, 302, 304) arranged for distinguishing blurred and non-blurred image portions of an input image, and
second means (105; 305) arranged for enhancing at least one of said blurred image portions of said input image to produce an output image.

16. The device (10) according to claim 15, wherein said first means comprises:
means (101) arranged for transforming at least a portion of said input image according to a first transformation to obtain a transformed input image portion;
means (102) arranged for enhancing a representation of said transformed input image portion to obtain an enhanced transformed input image portion;
means (103) arranged for transforming said transformed input image portion according to a second transformation; and
means (104) arranged for processing at least said portion of said input image, said enhanced transformed input image portion and an image portion, which is obtained by transforming said transformed input image portion according to said second transformation, to distinguish said blurred and non-blurred image portions of said input image.

17. The device according to claim 16, wherein said means (104) arranged for processing at least said portion of said input image, said enhanced transformed input image portion and said image portion, which is obtained by transforming said transformed input image portion according to said second transformation, comprises:
means (104) arranged for determining first differences between said enhanced transformed input image portion and said portion of said input image;
means (104) arranged for determining second differences between said image portion, which is obtained by transforming said transformed input image portion according to said second transformation, and said portion of said input image; and
means (104) arranged for comparing said first and second differences to distinguish blurred and non-blurred image portions of said input image.

18. The device (30) according to claim 15, wherein said first means comprises:
means (301) arranged for transforming at least a portion of said input image according to a first transformation to obtain a transformed input image portion;
means (302) arranged for enhancing a representation of said transformed input image portion to obtain an enhanced transformed input image portion; and
means (304) arranged for processing at least said portion of said input image, said enhanced transformed input image portion and said transformed input image portion to distinguish said blurred and non-blurred image portions of said input image.

19. The device according to claim 18, wherein said means (304) arranged for processing at least said portion of said input image, said enhanced transformed input image portion and said transformed input image portion comprises:
means (304) arranged for determining first differences between said enhanced transformed input image portion and said portion of said input image;
means (304) arranged for determining second differences between said transformed input image portion and said portion of said input image; and
means (304) arranged for comparing said first and second differences to distinguish blurred and non-blurred image portions of said input image.

20. The device according to claim 16, wherein said first (101, 102, 103, 104) and second (105) means form a unit (10, 10′-1, 10′-2), wherein N of these units are interconnected as a cascade (20) that produces a final output image from an original input image, wherein in each unit n=1, . . . ,N, an N−n fold transformed version of at least a portion of said original input image obtained from N−n fold application of said first transformation to said portion of said original input image is used as said input image, wherein in the first unit n=1, an N fold transformed version of said portion of said original input image obtained from N fold application of said first transformation to said portion of said original input image is used as said representation of said transformed input image portion, wherein in each other unit n=2, . . . ,N, at least a portion of said output image as produced by the preceding unit n−1 is used as said representation of said transformed input image portion, and wherein the output image produced in the last unit n=N is said final output image.
